(19) United States
(12) Patent Application Publication
(10) Pub. No.: US 2025/0037721 A1
(43) Pub. Date: Jan. 30, 2025

(54) CONTEXT-AWARE VOICE SELF-AUTHORIZATION

(71) Applicant: International Business Machines Corporation, Armonk, NY (US)

(72) Inventors: Su Liu, Austin, TX (US); Yang Liang, Beijing (CN); Terry James Hoffman, Austin, TX (US); Paul Llamas Virgen, Guadalajara (MX)

(21) Appl. No.: 18/359,174

(22) Filed: Jul. 26, 2023

(51) Int. Cl. G10L 17/02; G10L 17/06

(52) U.S. Cl. CPC G10L 17/02; G10L 17/06

(57) ABSTRACT

According to one embodiment, a method, computer system, and computer program product for context-aware voice self-authorization is provided. The embodiment may include identifying a speaker in audio data using two or more authentication techniques. The embodiment may also include capturing contextual information related to the audio data. The embodiment may further include encoding the contextual information into an audible voice. The embodiment may also include converting the audible voice to an inaudible sound frequency. The embodiment may further include embedding the inaudible sound frequency voice with audio data.

### BACKGROUND

The present invention relates generally to the field of computing, and more particularly to user authorization and authentication.

User authentication relates to the process of verifying the identity of a user prior to allowing that user access to a digital or physical location or service. Most modern security systems utilize user authentication as a critical component for data protection. Traditionally, user authentication has utilized the process of matching IDs and passwords provided by users to those stored on a server-side client. More modern authorization techniques utilize biometrics unique to individuals to authenticate user identities, such as fingerprint recognition or voice authentication.

Voice authentication relates to a type of biometric authentication that analyzes the characteristics of a user's unique vocal pattern to verify that user's identity similar to fingerprint analysis and facial scans. Voice authentication may provide a secure and efficient authentication method that allows users to access services or locations using speech.

### SUMMARY

According to one embodiment, a method, computer system, and computer program product for context-aware voice self-authorization is provided. The embodiment may include identifying a speaker in audio data using two or more authentication techniques. The embodiment may also include capturing contextual information related to the audio data. The embodiment may further include encoding the contextual information into an audible voice. The embodiment may also include converting the audible voice to an inaudible sound frequency. The embodiment may further include embedding the inaudible sound frequency voice with audio data.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for an authorized voice command generation process according to at least one embodiment.

FIG. 3 illustrates an operational flowchart for an authorized voice command verification process according to at least one embodiment.

FIG. 4 illustrates a functional block diagram of components for context-aware voice self-authorization according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to user authorization and authentication. The following described exemplary embodiments provide a system, method, and program product to, among other things, generating a form of voice authentication that encodes contextual information into spoken user speech as inaudible sounds to the human ear. Therefore, the present embodiment has the capacity to improve the technical field user authorization and authentication by eliminating certain threats of unauthorized access caused by digital replication of a user's voice.

As previously described, user authentication relates to the process of verifying the identity of a user prior to allowing that user access to a digital or physical location or service. Most modern security systems utilize user authentication as a critical component for data protection. Traditionally, user authentication has utilized the process of matching IDs and passwords provided by users to those stored on a server-side client. More modern authorization techniques utilize biometrics unique to individuals to authenticate user identities, such as fingerprint recognition or voice authentication.

Voice authentication relates to a type of biometric authentication that analyzes the characteristics of a user's unique vocal pattern to verify that user's identity similar to fingerprint analysis and facial scans. Voice authentication may provide a secure and efficient authentication method that allows users to access services or locations using speech.

Voice recognition and speech synthesis technologies are widely used in modern society with uses including speech-to-text and text-to-speech. Voice recognition is capable of enabling device unlocking without using a password or one's hands. Typically, voice recognition unlocking utilizes the timbre of a user's voice to authenticate the user is authorized to access the device or location. However, as with many technologies, bad actors may attempt to commit fraud by replicating the user's voice and thus gain unauthorized access to the device or location.

Common methods of gaining authorized access include voice fraud and artificial voice synthesis. Voice fraud relates to the use of phishing attacks using automated text-to-speech systems. In such situations, a user's voice is recreated as an audio deepfake to commit fraud by fooling people or devices into thinking they are receiving instruction from a trusted individual. Similarly, artificial voice synthesis, or voice cloning, utilizes a deep learning, artificial intelligence algorithm to create a synthetic voice that can mimic the voice of an authorized user or a trusted source, such as a company or government agency. This synthetic voice can be used to gain access to sensitive information or to carry out fraudulent activities. Voice cloning further enables the transfer of personal emotional expression, pronunciation characteristics, accent characteristics, and other information to the synthetic voice.

One of the ways such a cyberattack occurs is through unauthorized access to a device's voice recognition system and using it to create a digital replica of the user's, or another victim's, voice. The artificial intelligence algorithm at the heart of the cyberattack collects audio samples of the user's voice and, using machine learning algorithms, creates a voice model. The voice model can then be used to generate speech that sounds like the victim's voice.

Another method used to enable cyberattacks is through text-to-speech software that generates a synthetic voice sounding like a trusted source. The attacker can use such a synthetic voice to deceive a victim into providing sensitive information, such as passwords and personal identification information, and use that information to gain access to user accounts and data. As such, it may be advantageous to, among other things, utilize frequencies inaudible to human hearing to encode contextual information into an audio stream of recorded speech that can verify an authorized user's identity during the user authentication process.

According to at least one embodiment, a context-aware voice self-authorization program may capture user speech through a speech recorder and identify the speaker according to one or more authentication methods, such as fingerprint, voiceprint, eye scan, or password. The context-aware voice self-authorization program may collect contextual information about the captured speech, such as time, location, recording device, sensor ID, or application ID. Then, the context-aware voice self-authorization program may encode the collected contextual information into an audible voice, which in turn is converted into an inaudible frequency as a context-aware, self-authorized voice and merged with the recorded speech. The context-aware voice self-authorization program may subsequently utilize the merged recorded speech and inaudible voice to authorize the user in a manner that is not replicable through artificial voice synthesis.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

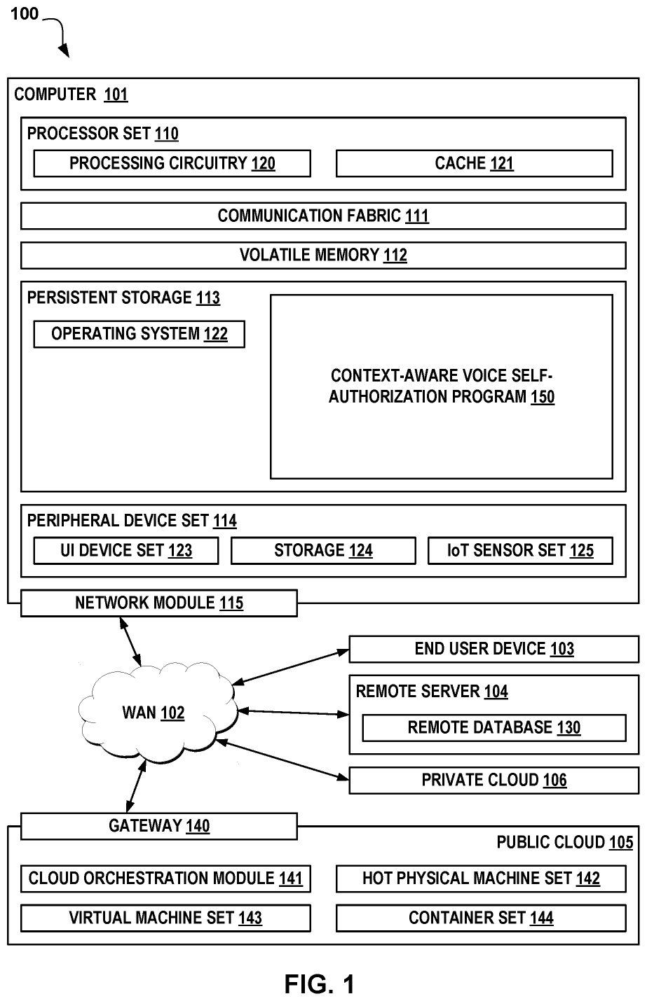

Referring now to FIG. 1, computing environment 100 contains an example of an environment for the execution of at least some of the computer code involved in performing the inventive methods, such as context-aware voice self-authorization program 150. In addition to context-aware voice self-authorization program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and context-aware voice self-authorization program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in context-aware voice self-authorization program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in context-aware voice self-authorization program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to at least one embodiment, the context-aware voice self-authorization program 150 may utilize contextual information related to a captured voice recording of a user to provide user authentication capabilities to the recorded voice data. The context-aware voice self-authorization program 150 may encode and convert the contextual information to an inaudible sound bite that can the be merged into the captured voice recording in a manner that will allow for user authentication data to be overlayed on the captured voice data. During a user authentication process, the context-aware voice self-authorization program 150 may extract and analyze the inaudible sound bite to determine whether the user should be authenticated.

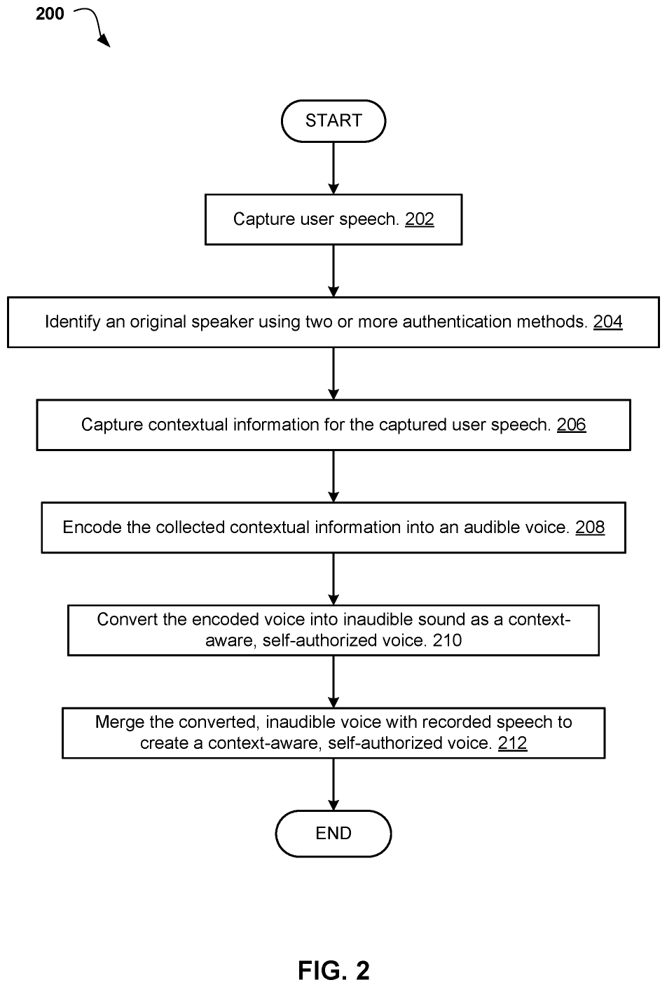

Additionally, prior to initially performing any actions, the context-aware voice self-authorization program 150 may perform an opt-in procedure. The opt-in procedure may include a notification of the data the context-aware voice self-authorization program 150 may capture and the purpose for which that data may be utilized by the context-aware voice self-authorization program 150 during data gathering and operation. Furthermore, notwithstanding depiction in computer 101, the context-aware voice self-authorization program 150 may be stored in and/or executed by, individually or in any combination, end user device 103, remote server 104, public cloud 105, and private cloud 106. The context-aware voice self-authorization method is explained in more detail below with respect to FIGS. 2-4.

Referring now to FIG. 2, an operational flowchart illustrating an authorized voice command generation process 200 is depicted according to at least one embodiment. At 202, the context-aware voice self-authorization program 150 captures user speech. When prompted to provide voice authentication, the context-aware voice self-authorization program 150 may capture user speech responsive to the voice authentication request prompt using a sensor, such as a microphone or any sensor within IoT sensor set 125, communicatively coupled to a user device, such as computer 101 or end user device 103. Upon capturing the user speech, the context-aware voice self-authorization program 150 may store the user speech in a repository, such as storage 124 or volatile memory 112.

Then, at 204, the context-aware voice self-authorization program 150 identifies an original speaker using two or more authentication methods. In order to ensure the user identity, the context-aware voice self-authorization program 150 may require an initial user authentication using two or more various technologies, such as but not limited to, fingerprint scanning, voiceprint analysis, iris scanning, and password verification. The context-aware voice self-authorization program 150 may determine the user identity through a search of a repository, such as storage 124, with registered user information, such as an employer database with baseline iris scans for a user or a personal user device with registered fingerprint scans. If a captured user authentication method matches the information within the repository within a threshold value, the context-aware voice self-authorization program 150 may certify the identity of the user as the matching information within the repository.

In one or more embodiments, the context-aware voice self-authorization program 150 may only perform the two or more authentication methods upon an initial identification of the user during a setup, or registration, process. In subsequent login processes, the context-aware voice self-authorization program 150 may require one authentication process or no authentication processes in addition to the authorized voice command generation process 200.

Next, at 206, the context-aware voice self-authorization program 150 captures contextual information for the captured user speech. Once a user is identified determined, the context-aware voice self-authorization program 150 may capture various items of contextual information surrounding the user speech, such as, but not limited to, current time, current date, location, recording/capturing device, sensor ID, and application ID.

In one or more embodiments, the context-aware voice self-authorization program 150 may generate a unique code for each item of contextual information, such as a numerical uniform time code for the time at which the speech was initially captured or an internet protocol address for the sensor that captured the speech. The amount of contextual information items captured may be user configurable based on the level of security sought by a user. For example, the user may configure the context-aware voice self-authorization program 150 to capture five items of contextual information in a desired order of importance and generate a numerical string of information corresponding to the top three items with which contextual information was captured. As supposed in this example, contextual information may be unavailable for some items. For example, a user may turn off location sharing on a user device or the user device may be in airplane mode thus preventing a current user location from being included in the contextual information. Continuing the previous example, the context-aware voice self-authorization program 150 may generate the numerical string of information by consecutively connecting, or appending, the numerical contextual information codes according to the user desired order of importance.

Then, at 208, the context-aware voice self-authorization program 150 encodes the collected contextual information into an audible voice. In preparation for converting the contextual information to inaudible sound data, the context-aware voice self-authorization program 150 may generate a sound file that conveys the contextual information but is still understandable by extraction module. For example, the context-aware voice self-authorization program 150 may convert the contextual information in a preconfigured order to speech using speech-to-text technology. In an embodiment that utilizes a unique numerical string as described above, the context-aware voice self-authorization program 150 may again utilize text-to-speech technology to recite each number of the numerical string.

In one or more embodiments, the context-aware voice self-authorization program 150 may vary the speech of the audible voice reciting the contextual information in order to fit the audible voice to the captured speech when the two are merged in step 212. For example, since the captured speech may typically be used for user authentication, the captured speech may only be a few seconds in length whereas the audible voice containing the captured contextual information may be longer than the length of the captured speech played as a speed that allows for human understanding. Therefore, the context-aware voice self-authorization program 150 may compress the length of the audible voice to fit the length of the captured speech thereby speeding up the audible voice. In an alternate embodiment, the context-aware voice self-authorization program 150 may perform the reverse and elongate the captured speech to match the length of the audible voice. In yet another embodiment, the context-aware voice self-authorization program 150 may set the length of both the captured speech and audible voice to a preconfigured length capable of analysis by a computing device, such as computer 101.

Next, at 210, the context-aware voice self-authorization program 150 converts the encoded voice into inaudible sound as a context-aware, self-authorized voice. The context-aware voice self-authorization program 150 may convert the audible voice to an inaudible sound so as to allow for open authentication of the captured speech but in a frequency that cannot be heard by the human ear without assistance, such as the ultrasonic range. The context-aware voice self-authorization program 150 may utilize any of a variety of audio post processing techniques to modify the audible voice to the inaudible sound.

Then, at 212, the context-aware voice self-authorization program 150 merges the converted, inaudible voice with the recorded speech. The context-aware voice self-authorization program 150 may merge, or overlay, the inaudible voice onto the recorded speech using any of a variety of audio post processing techniques. Therefore, the context-aware voice self-authorization program 150 may create a context-aware, self-authorized voice that consists of the recorded speech with the inaudible voice overlayed that can be used to authenticate the user speaking the recorded speech. Upon merging the inaudible voice with the recorded speech, the context-aware voice self-authorization program 150 may further encode and/or transmit the context-aware, self-authorized voice file from a device on which the context-aware voice self-authorization program 150 created the context-aware, self-authorized voice file to another device on which authentication of the user may be performed by a local version of the context-aware voice self-authorization program 150. For example, if a user records speech at a security checkpoint location in an attempt to enter a secure location for authorized individuals only, the context-aware voice self-authorization program 150 at the security checkpoint may capture user speech, generate an inaudible voice with contextual information, create a context-aware, self-authorized voice file by merging the inaudible voice and the captured speech, and transmitting the context-aware, self-authorized voice file to a central server, such as remote server 104, to perform a server-side authentication of the user with the context-aware, self-authorized voice file.

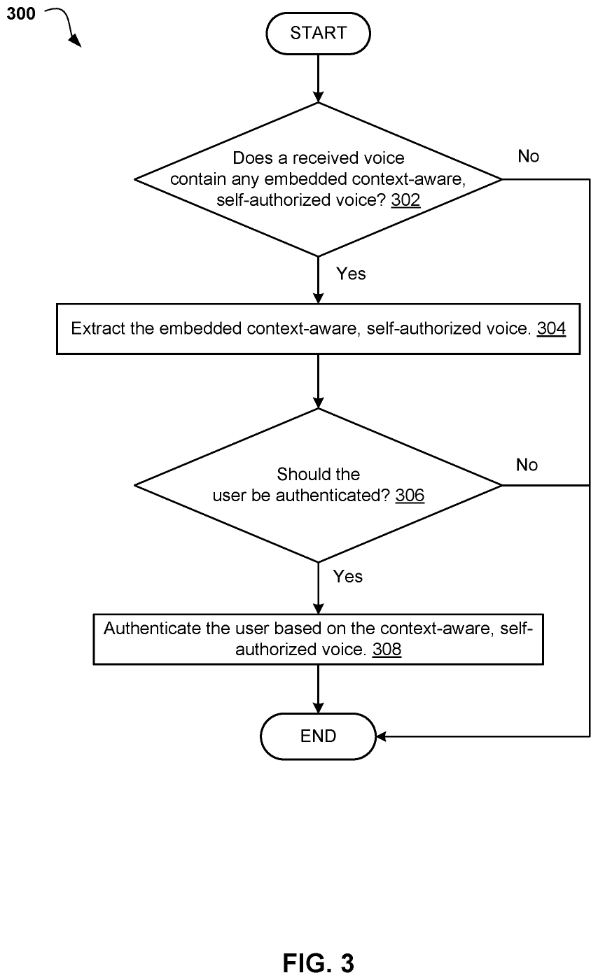

Referring now to FIG. 3, an operational flowchart illustrating an authorized voice command verification process 300 is depicted according to at least one embodiment. At 302, the context-aware voice self-authorization program 150 determines whether a received voice contains any embedded context-aware, self-authorized voice data. Upon receiving an audio file for authentication of the user, the context-aware voice self-authorization program 150 may first determine whether the received audio file contains any embedded context-aware, self-authorized voice data. The context-aware voice self-authorization program 150 may determine if the received audio file contains any embedded context-aware, self-authorized voice data through an analysis of the received audio file for any sound frequencies outside of the standard human hearing range, such as through ultrasound determination and extraction methods (e.g., high pass filtering and low pass filtering). For example, the context-aware voice self-authorization program 150 may analyze a received audio file for any sounds within the audio file that fall within the ultrasonic spectrum.

If the context-aware voice self-authorization program 150 determines the received voice data contains embedded context-aware, self-authorized voice data (step 302, “Yes” branch), then the authorized voice command verification process 300 may proceed to step 304 to extract the embedded context-aware, self-authorized voice data. If the context-aware voice self-authorization program 150 determines the received voice data does not contain embedded context-aware, self-authorized voice data (step 302, “No” branch), then the authorized voice command verification process 300 may terminate.

Next, at 304, the context-aware voice self-authorization program 150 extracts the embedded context-aware, self-authorized voice data. If the context-aware voice self-authorization program 150 determines the received voice data contains embedded context-aware, self-authorized voice data, possibly in a frequency range inaudible to the human ear, the context-aware voice self-authorization program 150 may proceed with extracting, or separating out, the context-aware, self-authorized voice data. The context-aware voice self-authorization program 150 may separate out the embedded context-aware, self-authorized voice data for further analysis to authenticate the user's identity. The context-aware voice self-authorization program 150 may extract the context-aware, self-authorized voice data through an extraction technique, such as frequency-based extraction.

Then, at 306, the context-aware voice self-authorization program 150 determines whether the user should be authenticated based on the extracted context-aware, self-authorized voice data. The context-aware voice self-authorization program 150 may determine whether to authenticate the user based on a comparison of the information within the context-aware, self-authorized voice against user profile information stored in a repository, such as remote database 130. The context-aware voice self-authorization program 150 may convert the context-aware, self-authorized voice sound file to text using speech-to-text technology. Thereafter, the context-aware voice self-authorization program 150 may compare the text-based information against user profile information in the server-side repository. The context-aware voice self-authorization program 150 may determine to authenticate a user when a preconfigured number of items in the context-aware, self-authorized voice match corresponding items in the user profile. For example, if an administrator has preconfigured the context-aware voice self-authorization program 150 to require at least three items in the context-aware, self-authorized voice data match items in the server-side repository, the context-aware voice self-authorization program 150 may reject authentication of a user when only two items in the context-aware, self-authorized voice match the corresponding user profile items in the server-side repository.

In one or more embodiments, the context-aware voice self-authorization program 150 may register various contextual information items to utilize when authenticating a user through the extracted context-aware, self-authorized voice. For example, when a user registers with the context-aware voice self-authorization program 150 during or before an initial authentication, the context-aware voice self-authorization program 150 may capture metadata related to one or more user devices (e.g., device ID, device location, device type, IP address, MAC address, device serial number, device model number, etc.), a user ID, a user location at access, an application ID, an access purpose, and a receiver ID. The context-aware voice self-authorization program 150 may store the captured metadata in user profile in a server-side repository, such as remote database 130.

In one or more other embodiments, the context-aware voice self-authorization program 150 may update the server-side metadata after a subsequent authentication since specific items of metadata may change from authentication to authentication. For example, if a user obtains a new user device, which in turn may have a different device ID but the same location and application ID from which the user is attempting to login, the context-aware voice self-authorization program 150 may authenticate the user, allow the user access, and update, modify, or add the new metadata to the existing metadata in the user profile in the server-side repository.

If the context-aware voice self-authorization program 150 determines user should be authenticated (step 306, “Yes” branch), then the authorized voice command verification process 300 may proceed to step 308 to authenticate the user. If the context-aware voice self-authorization program 150 determines the user should not be authenticated (step 306, “No” branch), then the authorized voice command verification process 300 may terminate.

Next, at step 308, the context-aware voice self-authorization program 150 authenticates the user based on the context-aware, self-authorized voice data. Once the context-aware voice self-authorization program 150 determines a user should be authenticated based on the analysis performed in step 306, the context-aware voice self-authorization program 150 may perform the actual authentication of the user. The authentication may include allowing the user physical or digital access to a location or a file to which the user was requesting. For example, if the user was attempting to access an organization intranet reserved for members of the organization and the context-aware voice self-authorization program 150 authenticated the user's voice using a provided context-aware, self-authorized voice, the context-aware voice self-authorization program 150 may allow the user access to the organization intranet.

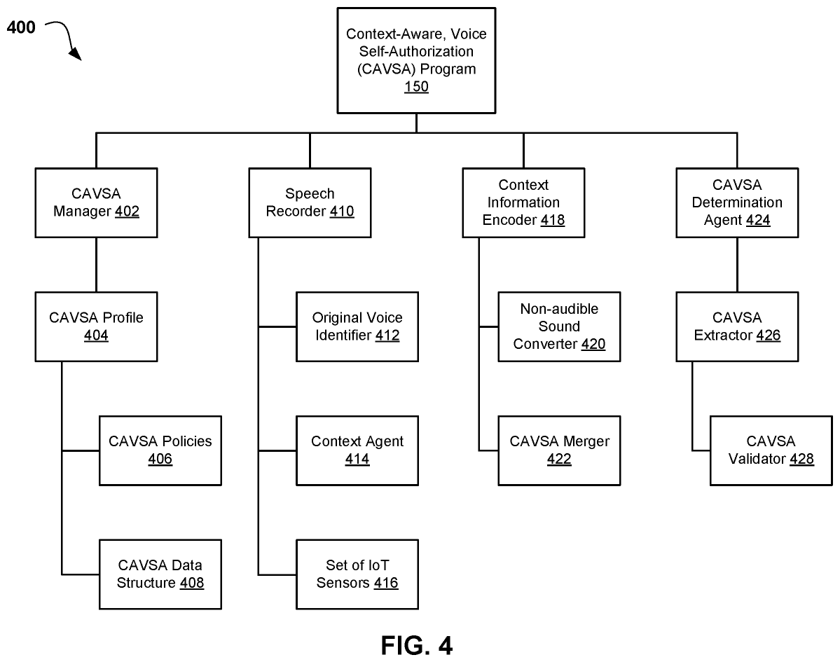

Referring now to FIG. 4, a functional block diagram of components 400 for context-aware voice self-authorization is depicted, according to at least one embodiment. The context-aware voice self-authorization program 150 may include a context-aware voice self-authorization manager 402, a speech recorder 410, a context information encoded 418, and a context-aware voice self-authorization determination agent 424. The context-aware voice self-authorization manager 402, the speech recorder 410, the context information encoded 418, and the context-aware voice self-authorization determination agent 424 may each have their own respective sub-entities as described below.

The context-aware voice self-authorization manager 402 may be a module for defining and managing a context-aware voice self-authorization profile 404, context-aware voice self-authorization policies 406, and a context-aware voice self-authorization data structure 408. The context-aware voice self-authorization profile 404, or service profile, may be a configuration file for the context-aware voice self-authorization program 150. The context-aware voice self-authorization profile 404 may be a profile with supporting services to standardize documentation of the context-aware voice self-authorization program 150 and capability metadata. The context-aware voice self-authorization data structure 408 may be a module unit for defining and tracking context-aware voice self-authorization information such as, but not limited to, a user ID, a device ID, an application ID, a timestamp, a location stamp, a purpose, an authorization expiration date, and a receiver ID. Context-aware voice self-authorization policies 406 may be a module unit for a defining context-aware voice self-authorization policy (e.g., types of contexts), encoding materials, and embedded frequencies of an inaudible voice (e.g., ultrasound frequency at 2 Mhtz).

The speech recorder 410 may be a module for recording user speech and may include, or be communicatively coupled to, an original voice identifier 412, a context agent 414, and a set of IoT sensors 416. The original voice identifier 412 may be a module unit for identifying an original speaker (e.g., a voice owner) according to multiple authentication methods (e.g., fingerprints, voiceprint, eye print, passwords, etc.). The context agent 414 may be a module unit for collecting context information (e.g., time, location, record device, sensor IDs, Application IDs, etc.). The set of IoT sensors 416, which may be one or more sensors included in IoT sensor set 125, may be a module unit for sensors to help identify, collect, and respond to required information.

The context information encoder 418 may be a module for encoding the collected context information into audible voice and may include, or be communicatively coupled to, the non-audible sound converter 420 and the context-aware voice self-authorization merger 422. The non-audible sound converter 420 may be a module unit for converting the encoded voice into non-audible sound as a context-aware, self-authorized voice. The context-aware voice self-authorization merger 422 may be a module unit for merging the converted non-audible context-aware, self-authorized voice with recorded speech so that each plays over the other simultaneously.

The context-aware voice self-authorization determination agent 424 may be a module for determining if a received voice contains any embedded context-aware, self-authorized voice and may include, or be communicatively coupled to, context-aware voice self-authorization extractor 426 and context-aware voice self-authorization validator 428. The context-aware voice self-authorization extractor 426 may be a module unit for extracting the embedded context-aware voice self-authorization information. The context-aware voice self-authorization validator 428 may be a module unit for validating the context-aware voice self-authorization information.

It may be appreciated that FIGS. 2-4 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying a speaker in audio data using two or more authentication techniques;
capturing contextual information related to the audio data;
encoding the contextual information into an audible voice;
converting the audible voice to an inaudible sound frequency; and
embedding the inaudible sound frequency voice with audio data.

2. The method of claim 1, further comprising:
receiving an audio file;
in response to determining the received audio file contains the inaudible sound frequency voice, extracting the embedded inaudible sound frequency voice; and
in response to determining the speaker should be authenticated, authenticating the speaker using the inaudible sound frequency voice.

3. The method of claim 1, wherein the embedding comprises overlaying the inaudible sound frequency voice over the audio data so each plays simultaneously in a merged audio data file.

4. The method of claim 1, wherein the encoding further comprises:
generating a unique, numerical code for each item of contextual information;
appending the codes together in a numerical string; and
converting the numerical string into the audible voice using text-to-speech technology.

5. The method of claim 1, wherein the inaudible sound frequency voice is in an ultrasonic frequency range.

6. The method of claim 1, wherein the two or more authentication techniques are selected from a group consisting of fingerprint scanning, voiceprint analysis, iris scanning, and password verification.

7. The method of claim 1, further comprising:
capturing the audio data using a sensor communicatively coupled to a computing device.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying a speaker in audio data using two or more authentication techniques;
capturing contextual information related to the audio data;
encoding the contextual information into an audible voice;
converting the audible voice to an inaudible sound frequency; and
embedding the inaudible sound frequency voice with audio data.

9. The computer system of claim 8, wherein the method further comprises:
receiving an audio file;
in response to determining the received audio file contains the inaudible sound frequency voice, extracting the embedded inaudible sound frequency voice; and
in response to determining the speaker should be authenticated, authenticating the speaker using the inaudible sound frequency voice.

10. The computer system of claim 8, wherein the embedding comprises overlaying the inaudible sound frequency voice over the audio data so each plays simultaneously in a merged audio data file.

11. The computer system of claim 8, wherein the encoding further comprises:
generating a unique, numerical code for each item of contextual information;
appending the codes together in a numerical string; and
converting the numerical string into the audible voice using text-to-speech technology.

12. The computer system of claim 8, wherein the inaudible sound frequency voice is in an ultrasonic frequency range.

13. The computer system of claim 8, wherein the two or more authentication techniques are selected from a group consisting of fingerprint scanning, voiceprint analysis, iris scanning, and password verification.

14. The computer system of claim 8, wherein the method further comprises:
capturing the audio data using a sensor communicatively coupled to a computing device.

15. A computer program product, the computer program product comprising:
one or more computer-readable tangible storage medium and program instructions stored on at least one of the one or more tangible storage media, the program instructions executable by a processor capable of performing a method, the method comprising:
identifying a speaker in audio data using two or more authentication techniques;
capturing contextual information related to the audio data;
encoding the contextual information into an audible voice;
converting the audible voice to an inaudible sound frequency; and
embedding the inaudible sound frequency voice with audio data.

16. The computer program product of claim 15, wherein the method further comprises:
receiving an audio file;
in response to determining the received audio file contains the inaudible sound frequency voice, extracting the embedded inaudible sound frequency voice; and
in response to determining the speaker should be authenticated, authenticating the speaker using the inaudible sound frequency voice.

17. The computer program product of claim 15, wherein the embedding comprises overlaying the inaudible sound frequency voice over the audio data so each plays simultaneously in a merged audio data file.

18. The computer program product of claim 15, wherein the encoding further comprises:
generating a unique, numerical code for each item of contextual information;
appending the codes together in a numerical string; and
converting the numerical string into the audible voice using text-to-speech technology.

19. The computer program product of claim 15, wherein the inaudible sound frequency voice is in an ultrasonic frequency range.

20. The computer program product of claim 15, wherein the two or more authentication techniques are selected from a group consisting of fingerprint scanning, voiceprint analysis, iris scanning, and password verification.
